(19) United States
(12) Patent Application Publication
(10) Pub. No.: US 2009/0122417 A1
(43) Pub. Date: May 14, 2009

(54) Tunable-Shape Prism

(75) Inventor: Sheng-Fa Hou, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/240,020

(22) Filed: Sep. 29, 2008

(30) Foreign Application Priority Data
Nov. 13, 2007 (CN) 200710168148.6

(51) Int. Cl. G02B 3/12; G02B 5/06

(52) U.S. Cl. 359/665; 359/832

(57) ABSTRACT

A tunable-shape prism comprises: a fluid chamber including a first fluid and a second fluid. The first fluid is electrically conducted and the second fluid is electrically insulated. The first fluid and the second fluid have different refractive indexes and the first fluid and the second fluid are non-miscible to each other. A meniscus is formed between the first fluid and the second fluid. A plurality of first electrodes are contacted with the first fluid and a plurality of second electrodes are even-annularly arranged around the first and the second fluids. The plurality of the second electrodes are coated by an insulator; and the plurality of the second electrodes and the corresponding first electrode together constitute a plurality of electrode pairs. The surface tension of the second fluid can be controlled by a plurality of voltages correspondingly applied to the plurality of electrode pairs, which results in that the shape of the meniscus can be controlled by the plurality of voltages correspondingly applied to the plurality of electrode pairs.

### FIELD OF THE INVENTION

The present invention relates to a tunable-shape prism, and more particularly to a tunable-shape prism developed through employing the electrowetting effect.

### BACKGROUND OF THE INVENTION

The main characteristic of the electrowetting effect is: the surface tension of a fluid or the contact angle between the fluid and a contact layer can be controlled by a voltage applied to the fluid. The wettability between the contact layer and the fluid also can be controlled by the applied voltage.

FIG. 1 is a cross-section diagram showing a variable focus lens disclosed in the U.S. Pat. No. 7,126,903, where the variable focus lens is developed based on the electrowetting effect. The variable focus lens includes: a fluid chamber 5 containing a fluid A and a fluid B, where the fluids A and B are non-miscible to each other; a first electrode 2; a second electrode 12; a transparent front element 4; a transparent back element 6; an insulating layer 8; a fluid contact layer 10; and a meniscus 14 formed between the fluids A and B. Moreover, a voltage can be applied between the first electrode 2 and the second electrode 12.

The fluid A is electrically insulated, such as silicone oil or the alkane; the fluid B is electrically conducted, such as water containing a salt solution. The fluids A and B are preferably arranged to have an equal density, therefore the lens functions independently of orientation, i.e. without dependence on gravitational effects between the two fluids. This may be achieved by appropriate selection of the fluid A; for example, the alkane or the silicon oil may be modified by addition of molecular constituents to increase their density to match that of the salt solution. The refractive index of fluid A is different with that of fluid B, where the refractive index of fluid A is greater than that of fluid B. The first electrode 2 is a cylinder, and formed on the cylindrically outer wall of the fluid chamber 5. To prevent from the contact with the fluids A and B, the first electrode 2 is coated by the insulating layer 8. The fluid contact layer 10 is on the cylindrically inner wall of the fluid chamber 5, and contacted with the fluids A and B. The second electrode 12 is annular, arranged at one end of the fluid chamber 5 and contacted with the fluid B. The transparent front element 4 is arranged on the left of the fluid chamber 5, and is referred to an entrance surface of light beams; the transparent back element 6 is arranged on the right of the fluid chamber 5, and is referred to an exit surface of light beams.

As depicted in FIG. 1, when an zero voltage (V₀=0) is applied between the first electrode 2 and the second electrode 12, the surface tension of fluid B is greater than that of fluid A, and the wettability between the contact layer 10 and the fluid B is relatively high; it follows that the contact angle (θ₀) between the fluid B and the contact layer 10 is greater than 90-degree (ex. 140-degree).

According to the electrowetting effect, the wettability between the contact layer 10 and the fluid B can be controlled by the voltage applied between the first electrode 2 and the second electrode 12. Moreover, the contact angle between the fluid B and the contact layer 10 is related to the wettability. Therefore, the shape of the meniscus 14 can be modified by the voltage applied between the first electrode 2 and the second electrode 12. In other words, the position of the focal point of the variable focus lens can be controlled through the voltage applied between the first electrode 2 and the second electrode 12.

The process of the applied voltage controlling the position of the focal point of the variable focus lens is more specifically explained in FIG. 2A and FIG. 2B. FIG. 2A is a cross-section diagram of the variable focus lens applied with a relatively low voltage. When a relatively low voltage (i.e. V₁=20˜150V) is applied between the first electrode 2 and the second electrode 12, the surface tension of fluid B is still greater than that of fluid A, and the wettability between the contact layer 10 and the fluid B is greater than that in the configuration (V₀=0) depicted in FIG. 1. Therefore, the contact angle (θ₁) is decreased to the range between 90-degree to 140-degree (ex. 100-degree). In the configuration (V₁=20˜150V), because the refractive index of fluid A is greater than that of fluid B, the variable focus lens functions as a concave lens having a negative lens power.

FIG. 2B is a cross-section diagram of the variable focus lens applied with a relatively high voltage. When a relatively high voltage (ex. V₂=150˜200V) is applied between the first electrode 2 and the second electrode 12, oppositely, the surface tension of fluid B is turned to less than that of fluid A, and the wettability between the contact layer 10 and the fluid B is greater than that in the configuration (V₁=20˜150V) depicted in FIG. 2A. Therefore, the contact angle (θ₂) is decreased below 90-degree (ex. 60-degree). In the configuration (V₂=150˜200V), because the refractive index of fluid A is greater than that of fluid B, the variable focus lens functions as a convex lens having a positive lens power.

Therefore, through employing the electrowetting effect, the shape of the meniscus 14 between the fluids A and B can be controlled by the voltage applied between the first electrode 2 and the second electrode 12, and eventually the position of the focal point of the variable focus lens can be controlled by the applied voltage.

However, because the variable focus lens is implemented by one electrode pair that is constituted by the first electrode 2 and second electrode 12, the deformation of the meniscus 14 is accordingly symmetrical when different magnitudes of voltage is applied. In other words, the variable focus lens functions as a concave lens or a convex lens, but cannot function as a prism capable of changing the direction of light beams.

Therefore, providing a tunable-shape prism by employing the electrowetting effect and adopting a number of electrode pairs is the main purpose of the present invention.

### SUMMARY OF THE INVENTION

Therefore, without requiring extra machinery for driving the optical components to different positions or angles, the present invention of the tunable-shape prism, through employing the electrowetting effect and a number of electrode pairs, is capable of guide light beams to any direction.

The present invention provides a tunable-shape prism comprising: a fluid chamber including a first fluid and a second fluid, wherein the first fluid is electrically conducted and the second fluid is electrically insulated. The first fluid and the second fluid have different refractive indexes and the first fluid and the second fluid are non-miscible to each other. A meniscus is formed between the first fluid and the second fluid. A plurality of first electrodes are contacted with the first fluid and a plurality of second electrodes are even-annularly arranged around the first and the second fluids. The plurality of the second electrodes are coated by an insulator; and the plurality of the second electrodes and the corresponding first electrode together constitute a plurality of electrode pairs. The surface tension of the second fluid can be controlled by a plurality of voltages correspondingly applied to the plurality of electrode pairs, which results in that the shape of the meniscus can be controlled by the plurality of voltages correspondingly applied to the plurality of electrode pairs.

Moreover, the present invention provides a tunable-shape prism comprising: a cylindrical fluid chamber having a cylindrical wall. The cylindrical fluid chamber is filled with a first fluid and a second fluid and the first and the second fluids are non-miscible to each other. There is a meniscus formed between the first and the second fluids and the first and the second fluids have different refractive indexes. A contact layer is arranged inside of the cylindrical wall. A plurality of first electrodes are contacted with the second fluid; and a plurality of second electrodes are even-annularly arranged on the outside of the cylindrical wall. The plurality of the second electrodes are coated by an insulator and the plurality of the second electrodes and the corresponding first electrode together constitute a plurality of electrode pairs. A wettability is existed between the second fluid and the contact layer, and the wettability is related to the shape of the meniscus. The wettability can be controlled by a plurality of voltages correspondingly applied to the plurality of the electrode pairs; and the shape of the meniscus can be also controlled by the plurality of voltages.

Moreover, the present invention provides a light system comprising: a light source; a lens; and a tunable-shape prism. The light beams emitted by the light source are appropriately modified by the lens, and then the modified light beams are emitted to the tunable-shape prism. By controlling voltages applied to a plurality of the electrode pairs in the tunable-shape prism, a meniscus in the tunable-shape prism can be sloped to any direction, and light beams passed through the tunable-shape prism can be controlled to any direction.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a cross-section diagram showing a variable focus lens disclosed in the U.S. Pat. No. 7,126,903, where the variable focus lens is developed based on the electrowetting effect;

FIG. 2A is a cross-section diagram of the variable focus lens applied with a relatively low voltage;

FIG. 2B is a cross-section diagram of the variable focus lens applied with a relatively high voltage;

FIG. 3A is the top-view diagram of the tunable-shape prism of the present invention;

FIG. 3B is the cross-section diagram of the tunable-shape prism of the present invention;

FIG. 4A to FIG. 4D are cross-section diagrams showing the change of the meniscus in the tunable-shape prism under configurations with different applied voltages;

FIG. 5 is a top-view diagram showing a tunable-shape prism of the present invention having ten electrode pairs (P1-P10); and

FIG. 6 is a diagram showing a light system employing the tunable-shape prism of the present invention.

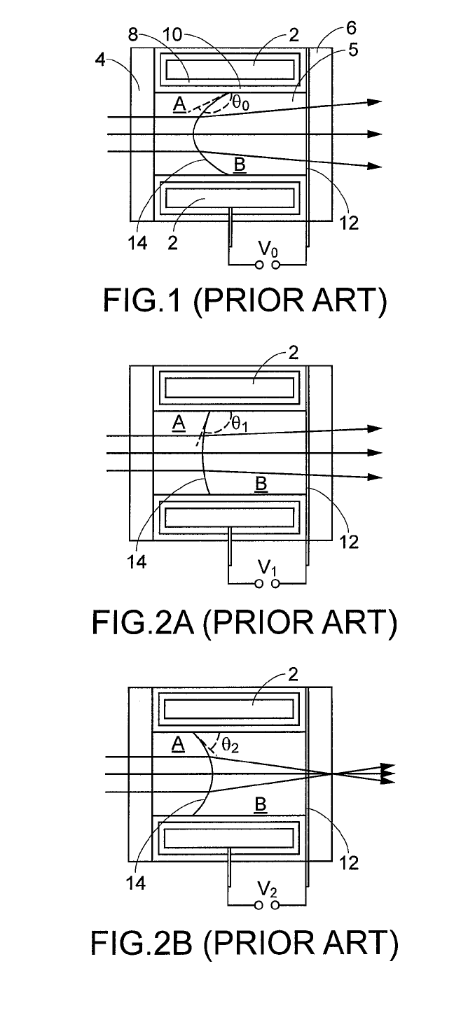

### DETAILED DESCRIPTION OF PREFERRED EMBODIMENTS

The present invention is a tunable-shape prism. Without requiring extra external machinery, the present invention of the tunable-shape prism can change the direction of light beams through employing the electrowetting effect and a number of electrode pairs.

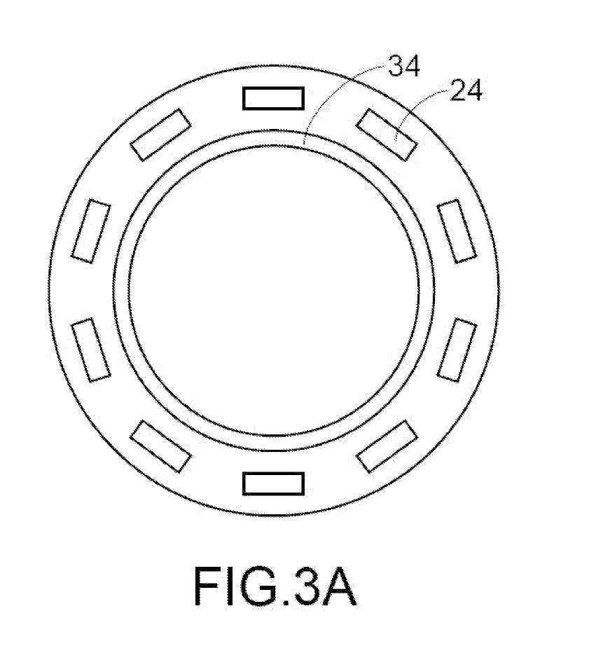

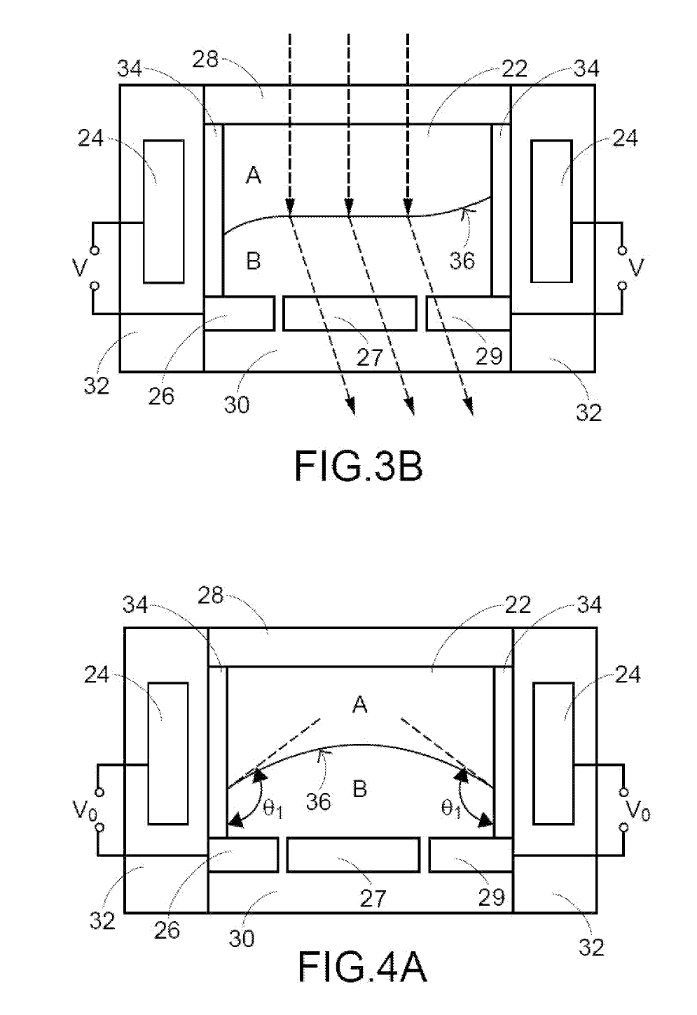

FIG. 3A and FIG. 3B are the top-view and the cross-section diagrams of the tunable-shape prism of the present invention, respectively. The tunable-shape prism includes: a cylindrical fluid chamber 22 filled with a fluid A and a fluid B, where the fluids A and B are non-miscible to each other; a plurality of first electrodes 24; a plurality of second electrodes; a first transparent layer 28; a second transparent layer 30; an insulator 32; a contact layer 34; and a meniscus 36 formed between the fluids A and B.

The fluid A is electrically insulated, such as the silicone oil or the alkane and the fluid B is electrically conducted, such as water containing a salt solution. The fluids A and B are preferably arranged to have an equal density, it follows that the prism functions independently of orientation, i.e. without dependence on gravitational effects between the two fluids. The refractive index of the fluid A is different with that of the fluid B, where the refractive index of the fluid B is greater than that of the fluid A in the embodiment of the present invention. The plurality of first electrodes 24 are even-annularly arranged on the cylindrically outer wall of the cylindrical fluid chamber 22. To prevent from the contact with the fluids A and B, the plurality of the first electrodes 24 are coated by the insulator 32. The plurality of second electrodes are arranged on the bottom of the fluid chamber 22, and contacted with the second fluid B. The plurality of second electrodes includes at least electrodes 26, 27 and 29 as shown in FIG. 3B. The plurality of second electrodes are transparent, therefore, light beams can pass through. The plurality of electrodes 24 and the corresponding second electrode together constitute a plurality of electrode pairs, for example, the first electrode pair 24 and 26, the second electrode pair 24 and 29. The contact layer 34 is arranged on the cylindrically inner wall of the fluid chamber 22, and contacted with the fluids A and B. The transparent layer 28 is arranged on the top of the fluid chamber 22, and is referred to an entrance surface of light beams; the transparent layer 30 is arranged on the bottom of the fluid chamber 22, and is referred to an exit surface of light beams.

According to the electrowetting effect, the wettability between the contact layer 34 and the fluid B or the contact angle between the fluid B and the contact layer 34, can be controlled by a voltage applied between the first electrode 24 and the second electrode 26 (electrode pairs). In the embodiment of the present invention, the voltage V₀ represents an zero voltage is applied between the first electrode 24 and the second electrode 26; the voltage V₁ represents a middle voltage is applied between the first electrode 24 and the second electrode 26; and the voltage V₂ represents a relatively high voltage is applied between the first electrode 24 and the second electrode 26. When V₀ is applied to the electrode pairs, because the surface tension of fluid B is greater than that of the fluid A, and the wettability between the contact layer 34 and the fluid B is relatively small, it results in that the contact angle between the fluid B and the contact layer 34 is greater than 90-degree (ex. θ₁). When V₁ is applied to the electrode pairs, because the surface tension of fluid B is equal to that of fluid A, and the wettability between the contact layer 34 and the fluid B is greater than that when V₀ is applied, it results in that the contact angle between the fluid B and the contact layer 34 is close to 90-degree (ex. θ₂). When V₂ is applied to the electrode pairs, because the surface tension of fluid B is turned to be less than that of fluid A, and the wettability between the contact layer 34 and the fluid B is greater than that when V₁ is applied, it results in that the contact angle between the fluid B and the contact layer 34 is less than 90-degree (ex. θ₃).

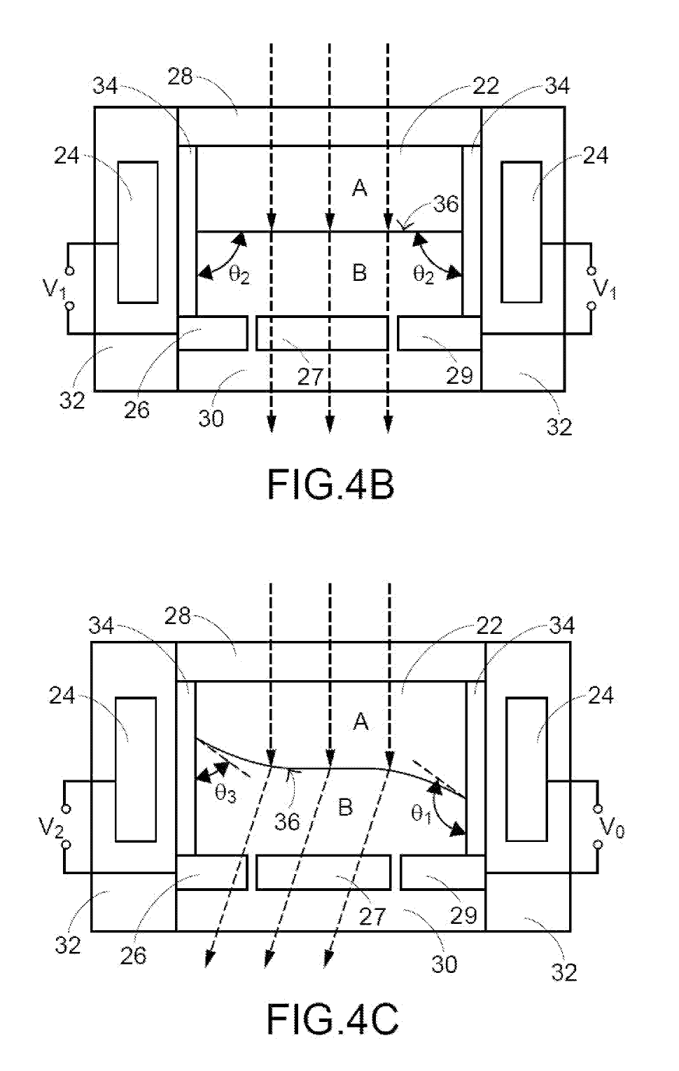

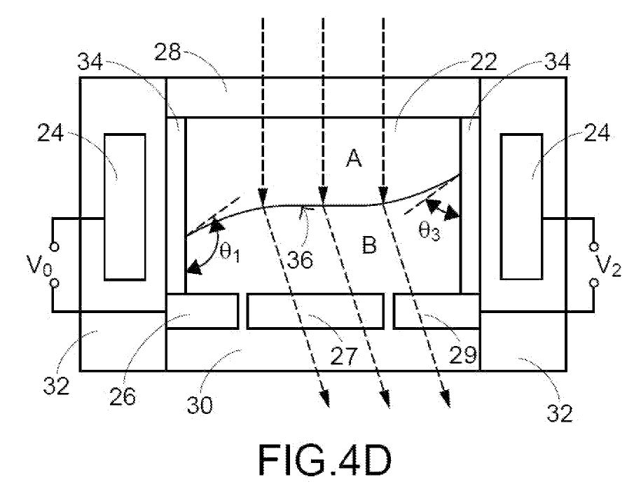

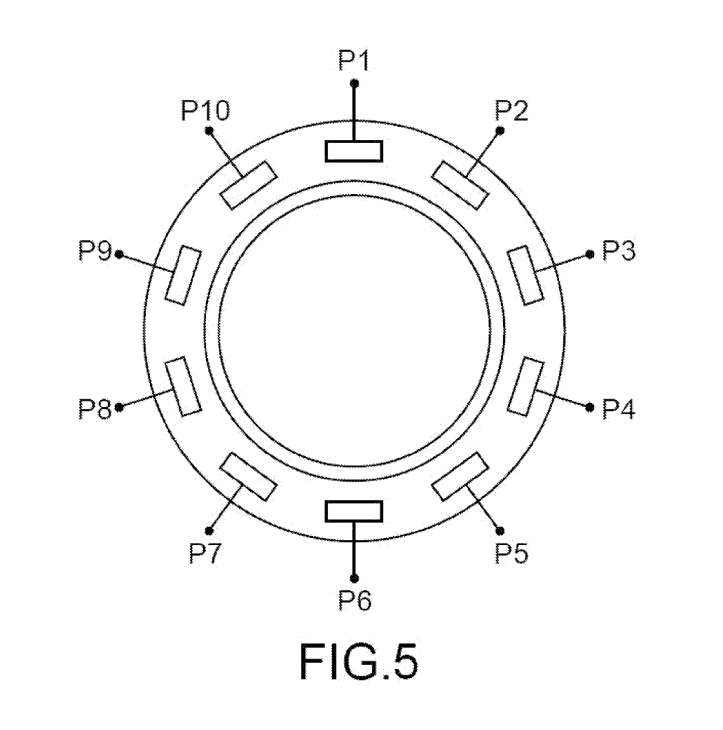

FIG. 4A to FIG. 4D are the cross-section diagrams showing the change of the meniscus in the tunable-shape prism with different applied voltages. FIG. 4A is a cross-section diagram showing the change of the meniscus in the tunable-shape prism under the configuration that the zero voltage (V₀) is applied to the left electrode pair and the right electrode pair. When the zero voltage (V₀) is applied to the left and right electrode pairs, the contact angle between the fluid B and the contact layer 34 on the left cylindrically inner wall of the fluid chamber 22 is greater than 90-degree (ex. θ₁); similarly, the contact angle between the fluid B and the contact layer 34 on the right cylindrically inner wall of the fluid chamber 22 is also greater than 90-degree (ex. θ₁).

FIG. 4B is a cross-section diagram showing the change of the meniscus in the tunable-shape prism under the configuration that the middle voltage (V₁) is applied to the left electrode pair and the right electrode pair. When the middle voltage (V₁) is applied to the left and right electrode pairs, the contact angle between the fluid B and the contact layer 34 on the left cylindrically inner wall of the fluid chamber 22 is equal to 90-degree (ex. θ₂); similarly, the contact angle between the fluid B and the contact layer 34 on the right cylindrically inner wall of the fluid chamber 22 is also equal to 90-degree (ex. θ₂). In the configuration, the light beam will not change its direction after passing through the tunable-shape prism of the present invention because the meniscus 36 is horizontal.

FIG. 4C is a cross-section diagram showing the change of the meniscus in the tunable-shape prism under the configuration that the high voltage (V₂) is applied to the left electrode pair and the zero voltage (V₀) is applied to the right electrode pair. In this embodiment, the plurality of second electrodes are electrodes 26, 27 and 29. When the high voltage (V₂) is applied to the left electrode pair (electrodes 24 and 26), the contact angle between the fluid B and the contact layer 34 on the left cylindrically inner wall of the fluid chamber 22 is less than 90-degree (ex. θ₃); when the zero voltage (V₀) is applied to the right electrode pair (electrodes 24 and 29), the contact angle between the fluid B and the contact layer 34 on the right cylindrically inner wall of the fluid chamber 22 is greater than 90-degree (ex. θ₁). In other words, the meniscus 36 is sloped to right. In the configuration, the light beam will change its direction to left after passing through the tunable-shape prism of the present invention.

FIG. 4D is a cross-section diagram showing the change of the meniscus in the tunable-shape prism under the configuration that the zero voltage (V₀) is applied to the left electrode pair and the high voltage (V₂) is applied to the right electrode pair. When the zero voltage (V₀) is applied to the left electrode pair (electrodes 24 and 26), the contact angle between the fluid B and the contact layer 34 on the left cylindrically inner wall of the fluid chamber 22 is greater than 90-degree (ex. θ₁); when the high voltage (V₂) is applied to the right electrode pair (electrodes 24 and 29), the contact angle between the fluid B and the contact layer 34 on the right cylindrically inner wall of the fluid chamber 22 is less than 90-degree (ex. θ₃). In other words, the meniscus 36 is sloped to left. In the configuration, the light beam will change its direction to right after passing through the tunable-shape prism of the present invention.

For more specifically explaining the process of tunable-shape prism of the present invention and controlling the direction of the light beams, an example of a tunable-shape prism having ten electrode pairs is illustrated below. FIG. 5 is a top-view diagram showing a tunable-shape prism having ten electrode pairs (P1-P10), where the ten electrode pairs (P1-P10) are even-annularly arranged on the cylindrically outer wall of the cylindrical fluid chamber 22. The light beams pass through the fluid A and the fluid B in the fluid chamber 22. Because the shape of the meniscus 36 between the fluids A and B can be controlled by voltages applied to the ten electrode pairs (P1-P10), it results in that the direction of the light beam can be controlled by the voltages. For example, if the direction of the passed light beam is needed to be changed to upper right, accordingly the meniscus 36 is necessary to be modified to slope to bottom left. The bottom left slope can be achieved through applying a high voltage to electrode pairs P2 and P3, applying a sub-high voltage to electrode pairs P1 and P4, applying a middle voltage to electrode pairs P5 and P10, applying a low voltage to electrode pairs P6 and P9, and applying an zero voltage to electrode pairs P7 and P8.

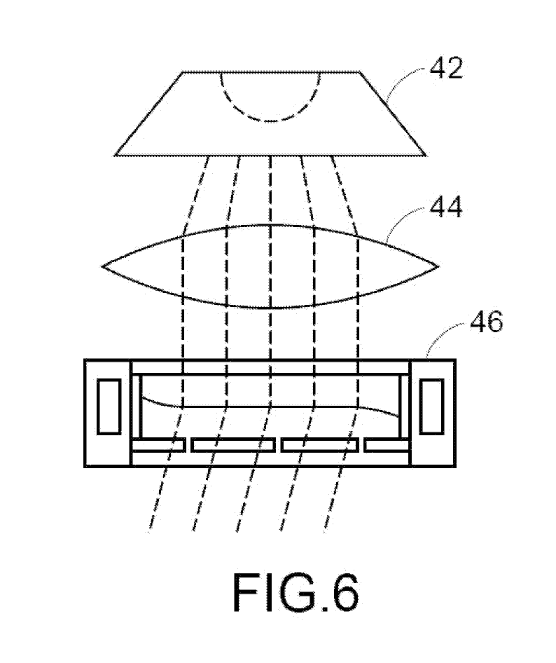

The tunable-shape prism of the present invention can be used as a component for changing the direction of the light beams in a light system. FIG. 6 is a diagram showing a light system employing the tunable-shape prism of the present invention. The light system includes: a light source 42, a lens 44, and a tunable-shape prism 46, where the light source 42 can be a LED (light-emitting diode). After light beams are emitted from the light source 42, the directions of the light beams are appropriately modified by the lens 44, and then the light beams are entering into the tunable-shape prism 46. Through controlling the magnitudes of the voltages applied to the electrode pairs in the tunable-shape prism 46, the meniscus in the tunable-shape prism 46 can be sloped to any direction; it follows that the direction of the light beams passed through the tunable-shape prism 46 can be controlled to any directions.

Through employing the tunable-shape prism in the light system, no extra machinery is needed for driving the optical components. Obviously, it follows that the size of the light system is reduced, and the noises generated from the process of the machinery driving the optical components can be avoided.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A tunable-shape prism, comprising:
a fluid chamber including a first fluid and a second fluid, wherein the first fluid is electrically conducted and the second fluid is electrically insulated, wherein the first fluid and the second fluid have different refractive indexes, wherein the first fluid and the second fluid are non-miscible to each other and there is a meniscus formed between the first fluid and the second fluid;
a plurality of first electrodes contacted with the first fluid; and
a plurality of second electrodes, wherein the plurality of second electrodes are even-annularly arranged around the first and the second fluids; wherein the plurality of the second electrodes are coated by an insulator and the plurality of the second electrodes and the corresponding first electrode together constitute a plurality of electrode pairs;
wherein the surface tension of the second fluid can be controlled by a plurality of voltages correspondingly applied to the plurality of electrode pairs, which results in that the shape of the meniscus can be controlled by the plurality of voltages correspondingly applied to the plurality of electrode pairs.

2. The tunable-shape prism according to claim 1, wherein the first and the second fluids are arranged to have a similar density.

3. The tunable-shape prism according to claim 1, wherein the fluid chamber is cylindrical.

4. The tunable-shape prism according to claim 1, wherein the meniscus can slope to any direction through applying the plurality of voltages correspondingly to the plurality of the electrode pairs, and the magnitude of the slope is related to the magnitude of the plurality of the voltages.

5. The tunable-shape prism according to claim 1, wherein the fluid chamber further includes a first transparent layer and a second transparent layer; wherein the first and second transparent layers are arranged at the two ends of the fluid chamber, respectively.

6. The tunable-shape prism according to claim 1, wherein the plurality of first electrodes are transparent.

7. The tunable-shape prism according to claim 1, wherein the tunable-shape prism functions as a lens if an zero voltage is applied to the plurality of electrode pairs.

8. A tunable-shape prism, comprising:
a cylindrical fluid chamber having a cylindrical wall, wherein the cylindrical fluid chamber is filled with a first fluid and a second fluid, wherein the first and the second fluids are non-miscible to each other, wherein there is a meniscus formed between the first and the second fluids and the first and the second fluids have different refractive indexes;
a contact layer inside the cylindrical wall;
a plurality of first electrodes contacted with the second fluid; and
a plurality of second electrodes, wherein the plurality of second electrodes are even-annularly arranged on the outside of the cylindrical wall and the plurality of the second electrodes are coated by an insulator, wherein the plurality of the second electrodes and the corresponding first electrode together constitute a plurality of electrode pairs;
wherein a wettability is existed between the second fluid and the contact layer, and the wettability is related to the shape of the meniscus; wherein the wettability can be controlled by a plurality of voltages correspondingly applied to the plurality of the electrode pairs and the shape of the meniscus can be controlled by the plurality of voltages.

9. The tunable-shape prism according to claim 8, wherein the first fluid is electrically insulated and the second fluid is electrically conducted.

10. The tunable-shape prism according to claim 8, wherein the first and the second fluids are arranged to have a similar density.

11. The tunable-shape prism according to claim 8, wherein the meniscus can slope to any direction through applying different magnitudes of voltages to the plurality of the electrode pairs, and the magnitude of the slope is related to the magnitude of the plurality of the voltages.

12. The tunable-shape prism according to claim 8, wherein the plurality of first electrodes are transparent.

13. The tunable-shape prism according to claim 8, wherein the fluid chamber further includes a first transparent layer and a second transparent layer and the first and second transparent layers are arranged at the two ends of the fluid chamber, respectively.

14. The tunable-shape prism according to claim 8, wherein the tunable-shape prism functions as a lens if an zero voltage is applied to the plurality of electrode pairs.

15. A light system, comprising:
a light source;
a lens; and
a tunable-shape prism;
wherein the light beams emitted by the light source are appropriately modified by the lens, and then the modified light beams are emitted to the tunable-shape prism; wherein by controlling voltages applied to a plurality of the electrode pairs in the tunable-shape prism, a meniscus in the tunable-shape prism can be sloped to any direction and then the light beams passed through the tunable-shape prism can be controlled to any direction.

16. The light system according to claim 15, wherein the light source is a light-emitting diode.
